(19) United States
(12) Patent Application Publication
(10) Pub. No.: US 2009/0135439 A1
(43) Pub. Date: May 28, 2009

(54) Method And Apparatus For Printing A High Resolution Image With A Printhead In A Multi-Pass Printing Mode

(76) Inventors: John Booth Bates, Harrodsburg, KY (US); Bruce Anthony DeBoard, Lexington, KY (US); Chingwen Li, Lexington, KY (US); Scott Michael Heydinger, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/945,366

(22) Filed: Nov. 27, 2007

(51) Int. Cl. G06K 15/02; G06K 15/10

(52) U.S. Cl. 358/1.8; 358/1.2

(57) ABSTRACT

A method of printing a high resolution image with a printhead in a multi-pass printing mode includes subdividing the high resolution image into a plurality of low resolution sub-images; subdividing each low resolution sub-image into a plurality of low resolution swath portions; and allocating an amount of a memory for buffer storage, the amount being only sufficient to store data corresponding to less than two of the low resolution swath portions. The method also includes, for each low resolution swath portion: halftoning each low resolution swath portion to generate a corresponding halftoned low resolution swath portion, the halftoning of each low resolution swath portion of a particular low resolution sub-image being performed independently of halftoning the low resolution swath portions of other low resolution sub-images; storing the halftoned low resolution swath portion into the amount of the memory; and printing the halftoned low resolution swath portion.

### CROSS-REFERENCE TO RELATED APPLICATIONS

This patent application is related to the U.S. patent application Ser. No. 11/463,117, filed Aug. 8, 2006, entitled “Method of Multipass printing using a plurality of halftone patterns of dots” and assigned to the assignee of the present application.

### MICROFICHE APPENDIX

None.

### GOVERNMENT RIGHTS IN PATENT

None.

### BACKGROUND OF THE INVENTION

1. Field of the Invention

The present invention relates to printing, and, more particularly, to a method and apparatus for printing a high resolution image with a printhead in a multi-pass printing mode.

2. Description of the Related Art

Ink jet printing systems produce images by printing patterns of dots on a sheet of print media, such as paper. The images sought to be printed by users typically include images created on a computer, such as a personal computer, images created by scanning a document or photograph, and images created by digital cameras. Driven to satisfy the needs of users, manufacturers of ink jet printing systems have implemented measures to increase the resolution at which an image may be printed. For example, image resolutions of 2400 dots per inch in both vertical and horizontal directions may be achieved by printing in a multi-pass printing mode, wherein the higher resolution image is achieved by printing with multiple passes of the printhead, and typically by indexing the print media between passes.

However, the higher resolution images require greater memory capability in both the printer and the host computer than those systems capable of reproducing only lower resolution images. For example, for a 2400×2400 dpi image yields 5,760,000 dots per square inch on the print media. This requires substantially more image processing buffer memory than a 600×600 dpi image, which yields 360,000 dots per square inch on the print media. Accordingly, it would be desirable to reduce the amount of memory required in order to print higher resolution images.

What is needed in the art is an improved imaging apparatus and method for printing an image with a printhead in a multi-pass printing mode.

### SUMMARY OF THE INVENTION

The present invention relates to an imaging apparatus and method for printing an image with a printhead in a multi-pass printing mode.

The invention, in one form thereof, is directed to a method of printing a high resolution image with a printhead in a multi-pass printing mode. The method includes subdividing the high resolution image into a plurality of low resolution sub-images; subdividing each low resolution sub-image of the plurality of low resolution sub-images into a plurality of low resolution swath portions; and allocating an amount of a memory for buffer storage, the amount being only sufficient to store data corresponding to less than two of the low resolution swath portions. In addition, the method includes, for each low resolution swath portion of the plurality of low resolution swath portions: halftoning each low resolution swath portion to generate a corresponding halftoned low resolution swath portion, the halftoning of each low resolution swath portion of a particular low resolution sub-image being performed independently of halftoning the low resolution swath portions of other low resolution sub-images of the plurality of low resolution sub-images; storing the halftoned low resolution swath portion into the amount of the memory; and printing the halftoned low resolution swath portion.

The invention, in another form thereof, is directed to an imaging apparatus configured for printing a high resolution image in a multi-pass printing mode. The imaging apparatus includes a printhead; a print engine having a reciprocating printhead carrier configured to carry the printhead; and at least one of a controller and an imaging driver; and a memory. The at least one of the controller and the imaging driver are configured for executing program instructions for printing in a multi-pass printing mode by: subdividing the high resolution image into a plurality of low resolution sub-images; subdividing each low resolution sub-image of the plurality of low resolution sub-images into a plurality of low resolution swath portions; and allocating an amount of the memory for buffer storage, the amount being only sufficient to store data corresponding to less than two of the low resolution swath portions; and for each low resolution swath portion of the plurality of low resolution swath portions: halftoning each low resolution swath portion to generate a corresponding halftoned low resolution swath portion, the halftoning of each low resolution swath portion of a particular low resolution sub-image being performed independently of halftoning the low resolution swath portions of other low resolution sub-images of the plurality of low resolution sub-images; storing the halftoned low resolution swath portion into the amount of the memory; and printing the halftoned low resolution swath portion.

### BRIEF DESCRIPTION OF THE DRAWINGS

The above-mentioned and other features and advantages of the present invention, and the manner of attaining them, will become more apparent and the invention will be better understood by reference to the following description of embodiments of the invention taken in conjunction with the accompanying drawings, wherein:

FIG. 1 is a diagrammatic depiction of a system employed in accordance with an embodiment of the present invention.

FIG. 2 is a diagrammatic representation of a printhead defining a swath on a page.

FIG. 3 is a flowchart depicting a method of printing a high resolution image with a printhead in a multi-pass printing mode in accordance with an embodiment of the present invention.

FIG. 4 is a graphical representation of a high resolution image employed in describing embodiments of the present invention.

FIGS. 5A-5D are graphical representations of low resolution sub-images in accordance with embodiments of the present invention.

### DETAILED DESCRIPTION OF THE INVENTION

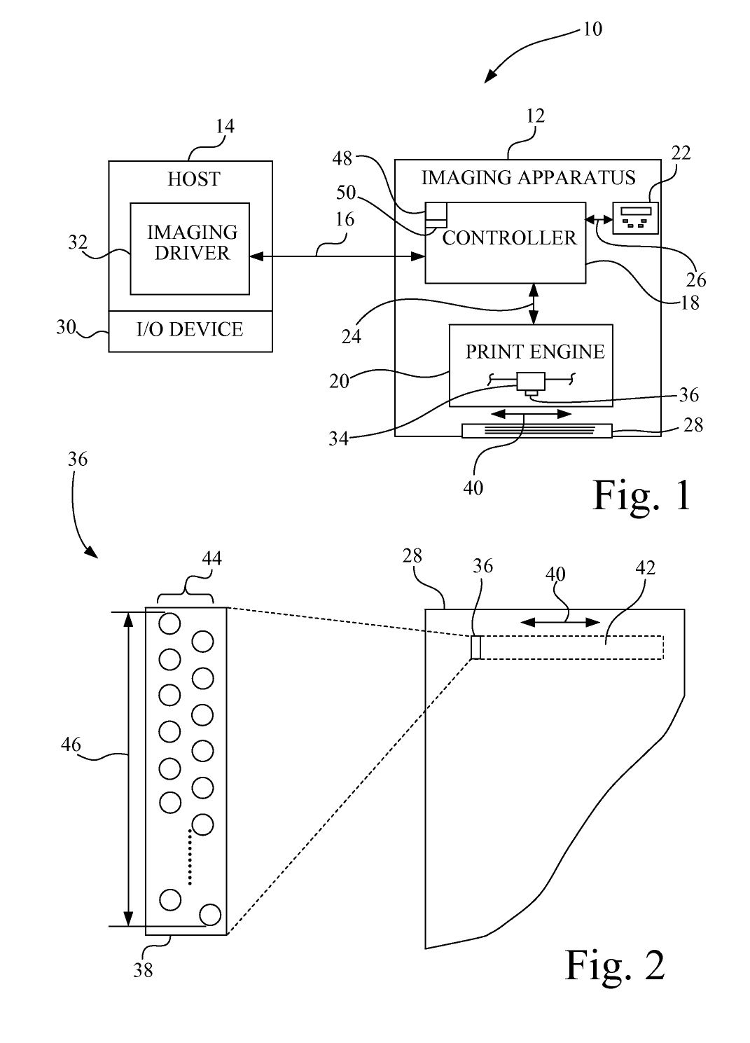

There is shown FIG. 1 a diagrammatic depiction of a system 10 embodying the present invention. System 10 may include an imaging apparatus 12 and a host 14, with imaging apparatus 12 communicating with host 14 via a communications link 16. Alternatively, imaging apparatus 12 may be a standalone unit that is not communicatively linked to a host, such as host 14. For example, imaging apparatus 12 may take the form of a multifunction machine that includes standalone copying and facsimile capabilities, in addition to optionally serving as a printer when attached to a host, such as host 14.

Imaging apparatus 12 may be, for example, an ink jet printer and/or copier. Imaging apparatus 12 includes a controller 18, a print engine 20 and a user interface 22.

Controller 18 includes a processor unit and associated memory, and may be formed as an Application Specific Integrated Circuit (ASIC). Controller 18 communicates with print engine 20 via a communications link 24. Controller 18 communicates with user interface 22 via a communications link 26.

In the context of the examples for imaging apparatus 12 given above, print engine 20 may be, for example, an ink jet print engine configured for forming an image on a page 28, e.g., a sheet of print media, such as a sheet of paper, transparency or fabric.

Host 14 may be, for example, a personal computer including an input/output (I/O) device 30, such as keyboard and display monitor. Host 14 further includes a processor, input/output (I/O) interfaces, memory, such as RAM, ROM, NVRAM, and a mass data storage device, such as a hard drive, CD-ROM and/or DVD units. During operation, host 14 includes in its memory a software program including program instructions that function as an imaging driver 32, e.g., printer driver software, for imaging apparatus 12. Imaging driver 32 is in communication with controller 18 of imaging apparatus 12 via communications link 16. Imaging driver 32 facilitates communication between imaging apparatus 12 and host 14, and may provide formatted print data to imaging apparatus 12, and more particularly, to print engine 20.

Alternatively, however, all or a portion of imaging driver 32 may be located in controller 18 of imaging apparatus 12. For example, where imaging apparatus 12 is a multifunction machine having standalone capabilities, controller 18 of imaging apparatus 12 may include an imaging driver configured to support a copying function, and/or a fax-print function, and may be further configured to support a printer function. In this embodiment, the imaging driver facilitates communication of formatted print data to print engine 20. In any event, imaging driver 32 is considered to be a part of imaging apparatus 12.

Communications link 16 may be established by a direct cable connection, wireless connection or by a network connection such as for example an Ethernet local area network (LAN). Communications links 24 and 26 may be established, for example, by using standard electrical cabling or bus structures, or by wireless connection.

Print engine 20 may include, for example, a reciprocating printhead carrier 34 that carries at least one ink jet printhead 36, and may be mechanically and electrically configured to mount, carry and facilitate multiple cartridges, such as a monochrome printhead cartridge and/or one or more color printhead cartridges, each of which includes a respective printhead 36. For example, in systems using cyan, magenta, yellow and black inks, printhead carrier 34 may carry four printheads, one printhead for each of cyan, magenta, yellow and black. As a further example, a single printhead, such as printhead 36, may include multiple ink jetting arrays, with each array associated with one color of a plurality of colors of ink. In such a printhead, for example, printhead 36 may include cyan, magenta, and yellow nozzle arrays for respectively ejecting full strength cyan (C) ink, full strength magenta (M) ink and yellow (Y) ink. Further, printhead 36 may include dilute colors, such as dilute cyan (c), dilute magenta (M), etc. The term, dilute, is used for convenience to refer to an ink that is lighter than a corresponding full strength ink of substantially the same hue, and thus, such dilute inks may be, for example, either dye based or pigment based. Printing with such inks may be referred to as CMYKcm printing.

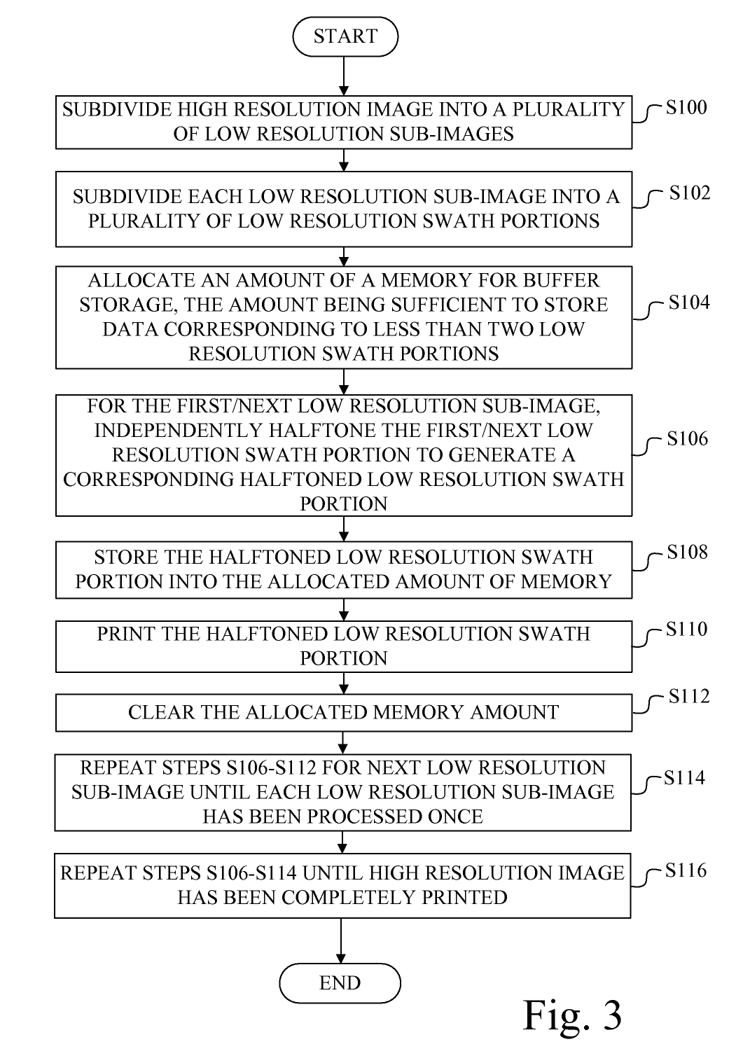

FIG. 2 illustrates an exemplary nozzle configuration of printhead 36, including a monochrome nozzle array 38 for ease of discussion. Printhead carrier 34 is controlled by controller 18 to move printhead 36 in a reciprocating manner along a bi-directional scan path 40, which will also be referred to herein as horizontal direction 40. Each left to right, or right to left movement of printhead carrier 34 along bi-directional scan path 40 over page 28 will be referred to herein as a pass. The region traced by printhead 36 when printing on page 28 for a given pass is referred to herein as a swath, such as for example, swath 42 as shown in FIG. 2.

In the exemplary nozzle configuration for ink jet printhead 36 shown in FIG. 2, nozzle array 38 includes a plurality of ink jetting nozzles 44. As within a particular nozzle array, the nozzle size may be, but need not be, the same size. In the present embodiment, a swath height 46 of swath 42 corresponds to the distance between the top of the uppermost and the bottom of the lowermost of the nozzles of printhead 36. However, it will be understood that swath height 46 pertains to the distance between the top of the uppermost and the bottom of the lowermost nozzles of a contiguous set of nozzles that are used for printing during normal printing operations, e.g., after installation and alignment of printheads for printers having more than one printhead.

For purposes of clarity, the present description of embodiments is made with regard to imaging apparatus 12 having a single printhead 36 having monochrome nozzle array 38. However, it will be recognized by those skilled in the art that one or more color and/or monochrome printheads may be employed without departing from the scope of the present invention. For example, the present invention is equally applicable where printhead 36 is a color printhead including multiple arrays representing a plurality of primary full strength colors and/or dilute colors of ink, or where printhead 36 is one of a plurality of monochrome and/or color printheads.

In order to print an image with print engine 20, the image data, e.g., RGB (red, green, blue) data generated by host 14, is converted into a form that compatible with print engine 20 and printhead 36 by a data converter 48. Data converter 48 performs color space conversion, and performs halftoning and formatting of the input image data, and may be implemented in software, firmware, hardware, or a combination thereof, and may be in the form of program instructions and associated data arrays and/or lookup tables.

In the present embodiment, data converter 48 is considered a part of and resides in controller 18. However, it is alternatively contemplated that in other embodiments, data converter 48 may be located in imaging driver 32 of host 14, or a portion of data converter 48 may be located in each of imaging driver 32 and controller 18.

The color space conversion process converts color signals from the image input source's color space to the imaging apparatus's color space, i.e., takes signals from one color space domain and converts them into signals of another color space domain for each image that is printed. For example, the color space conversion may convert from a light-generating color space domain of a color display monitor that utilizes primary colors red (R), green (G) and blue (B) to a light-reflective color space domain of a color printer that prints using cyan (C), magenta (M), yellow (Y) and black (K) ink colors.

In the present embodiment, the halftoning is error diffusion halftone processing, which is binarization algorithm that converts shades of colorants (such as cyan, magenta, and yellow color signals that were converted from RGB color signals) into print/no print decisions at each pixel location in the printed image, wherein error obtained based on the print/no print decision for one pixel location is diffused to other pixel locations, e.g., adjacent pixel locations. The objective of halftoning is to produce pleasing patterns of discrete dots that are imperceptible to the human eye, so that what appears to the human eye is an integrated continuous image.

As used herein, formatting pertains to an algorithm that receives print/no print decisions from the halftoning algorithm, typically one raster (i.e. row of pixel locations) at a time, stores the binary raster information until a predetermined number of rasters have been received, then instructs the printhead to scan across a page and deposit dots at pixel locations on a piece of print media, such as page 28. The output of the halftoning algorithm is stored in a buffer memory 50, from which the data is retrieved for formatting and printing.

To improve the quality of images printed by inkjet prints, resolution may be increased by increasing the number of pixel locations and decreasing the spacing between each pixel location on the image, e.g., printing a high resolution image at 2400 dpi×2400 dpi yields a higher resolution printed image result than printing the same image at 600 dpi×600 dpi. Nonetheless, however, printhead may not natively print at such high resolutions. For example, ink jet printhead 36 is configured with nozzle spacing to print pixel locations corresponding to a 600×600 dpi set of pixel locations on a given scan. This is due to a) the fact that nozzles are spaced 1/600″ apart vertically rather than 1/2400″ apart vertically, and b) at common carrier speeds the drop ejection chambers may not be able to fire and subsequently refill fast enough to jet ink onto page 28 at a firing frequency corresponding to 2400 dpi horizontally.

Thus, in order to achieve a higher resolution, such as a 2400×2400 dpi resolution, from a printhead that natively prints at 600×600 dpi, multiple 600×600 dpi scans (passes) of the printhead are utilized to fill in a 2400×2400 dpi grid. To fill in the grid, the scans are shifted with respect to each other by indexing page 28 between passes, as well as shifting scans relative to each other horizontally. For the present example the scans must be shifted through all sixteen combinations of (+ 0/2400″, + 1/2400″, + 2/2400″, and + 3/2400″) both horizontally and vertically and printed on a total of 16 scans. Hence, in the present example, the multi-pass printing is 16-pass printing, that is, requiring 16 passes to print all the dots of a high resolution image for any particular area of the image.

However, by increasing the resolution, the processing required for haltoning and formatting is larger, since there are more pixels to process in order to print the image. Halftoning includes the determining at a given pixel location whether or not a drop of ink is to be printed, referred to herein as the print/no print decision, and depending on this determination, an error is computed and propagated to neighboring pixel locations. Thus, with error diffusion halftoning, this error from the present pixel location then influences whether or not pixels are printed at other pixel locations.

Since error diffusion of each pixel location of the intended 2400×2400 print grid of the printed image may influence other pixel locations, 15 out of 16 of which may be printed on different passes of the printhead, all pixel locations in a given print area must be halftoned by an error diffusion algorithm operating at 2400×2400 dpi in order to maintain the desired relationships between the dots. Further, all of the 2400×2400 dpi pixel locations must be processed, i.e. halftoned, prior to printing even the first of the sixteen passes. In this manner, the multiple 600×600 dpi passes over a 2400×2400 grid may be said to be dependent on one another.

Thus, a disadvantage of error diffusion processing is that a large amount of memory is required in the imaging apparatus in order to perform stand alone high resolution printing.

For example, assuming a printhead contains 320 nozzles spaced 1/600″ apart vertically for a total height of 320/600″, the amount of memory required in the process of halftoning and formatting must be sufficient to store a 2400×2400 dpi image 8 inches wide and a height corresponding to the approximately ½″ height of the printhead which yields:

(2400 dots/inch*8 inch)*(320 dots/600 inch tall*2400)*(6 inks CMYKcm)=147,456,000 bits=approx 17.5 MB of memory.

In contrast, the amount of memory required for a single 600×600 dpi swath is:

(600 dots/inch*8 inch)*(320 dots tall)*(6 inks CMYKcm)=9,216,000 bits=approx 1.1 MB

Thus, it is clear that there is a significant difference between the amount of memory required to store an entire print area at a high resolution (2400×2400 dpi) and the amount of memory required to store a single low resolution pass (600×600 dpi) of the printhead corresponding to a subset of the high resolution grid.

In order to overcome this large memory requirement, the present invention essentially combines halftoning and formatting in a manner such that a smaller amount of information required by a single low-resolution swath is stored. The large amount of memory required for the high resolution example may be eliminated by virtue of the present invention, since the halftoning and formatting of the multiple low resolution print swaths of a high resolution print mode are such that the low resolution swaths are not dependent on one another.

Thus, rather than error diffusing the image at the high resolution (e.g., 2400×2400 dpi) to produce one diffused pattern and then printing different mutually exclusive portions of the one pattern on multiple passes, one aspect of the present invention employs a technique of error diffused shingling of the image in which the image is halftoned multiple times at low resolution (e.g., 600 dpi) and each halftone product is printed directly as an individual pass as a low resolution portion of the image. Each of the individual low resolution halftones is independent of each of the others, so that each of the printing passes is independent of the others, i.e. they are uncorrelated or statistically independent. Since error diffusion is still used in the process of producing each of the multiple passes, the resulting image retains an overall pleasing appearance.

Because each of the printing passes is independent of each of the others, the disadvantages of requiring a large amount of memory, as is required by the prior art, may be avoided. Thus, in accordance with an aspect of the present invention, a high resolution printing technique includes (1) preparing a first low resolution pattern of dots utilizing error diffusion corresponding to an image area having a height corresponding to a swath height of the printhead, and storing the results in a memory area; (2) using the stored results to print a first print swath corresponding to the first low resolution pattern of dots, after which the data from the first low resolution pattern is cleared from the memory area; (3) preparing a second low resolution pattern of dots utilizing error diffusion corresponding to a second image area having a height corresponding to a swath height of the printhead and, storing the results in the same memory area utilized for the first low resolution pattern; and (4) using the stored results to print a second print swath corresponding to the second low resolution pattern of dots.

The first and second image areas may correspond to the same part of the final high resolution image, or may only partially represent the same part of the high resolution image. Nonetheless, based on the present invention, for a 2400×2400 dpi image of the previous example, instead of storing 2400 dots per inch horizontally, only 600 horizontal dots per inch must be stored. In addition, instead of storing (320 dots/600 inch tall*2400) dots vertically, only 320 vertical dots must be stored, which reduces the required amount of buffer memory, i.e., memory 50. For example,

(600 dots/inch*8 inch)*(320 nozzles)*(6 inks CMYKcm)=9,216,000 bits approx 1.1 MB,

which corresponds to the storage area of a single swath. However, it is to be noted that since the image area is processed multiple times corresponding to each of the swaths, a portion of the image must be buffered to be presented multiple times to the halftone. This may or may not occur, depending on the embodiment, but to be conservative, a term may be added to account for it. Advantageously, the data can be stored in RGB space, requiring only 3 values per pixel, instead of 6 values for CMYKcm space. The amount of memory required according to the present invention is therefore:

(600 dots/inch*8 inch)*(320 nozzles)*(3 bytes RGB)=4,608,000 bytes approx 4.4 MB

Therefore, the amount of memory required to print a high resolution CMYKcm image according to the present invention is 1.1+4.4=5.5 MB, compared to a 17.5 MB requirement absent the present invention, which yields a substantial reduction in the required size of the buffer memory 50.

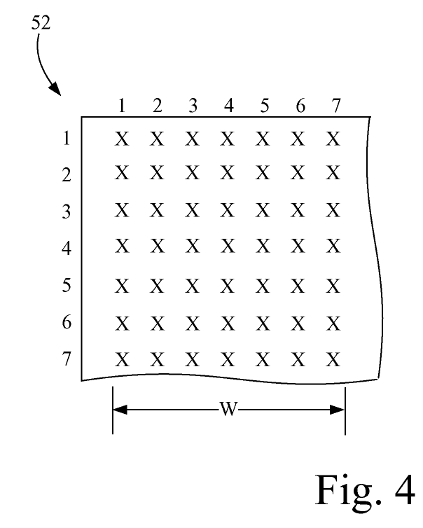

Referring now to FIG. 3 and steps S100-S116, a method of printing a high resolution image with a printhead in a multi-pass printing mode in accordance with an embodiment of the present invention is depicted. With multi-pass printing, multiple passes of the printhead are required in order to print all the dots in a given area of the image. A multi-pass printing mode has a number of passes associated with it, which varies depending upon the desired print resolution.

The method of steps S100-S116 is performed by data converter 48, which in the present embodiment is considered apart of controller 18, and hence, steps S100-S116 are performed by controller 18. However, it is alternatively considered that in other embodiments, the presently described method may be performed by data converter 48 in the form of imaging driver 32 alone, or in the form of a combination of controller 18 and imaging driver 32.

In any case, although the present embodiment is described with respect to a particular sequence, i.e., steps S100-S116, it will be understood that the present invention is not limited to that particular sequence. Rather, the described sequence is for illustrative purposes only. As would be appreciated by one of ordinary skill in the art, other sequences may be employed without departing from the scope of the present invention.

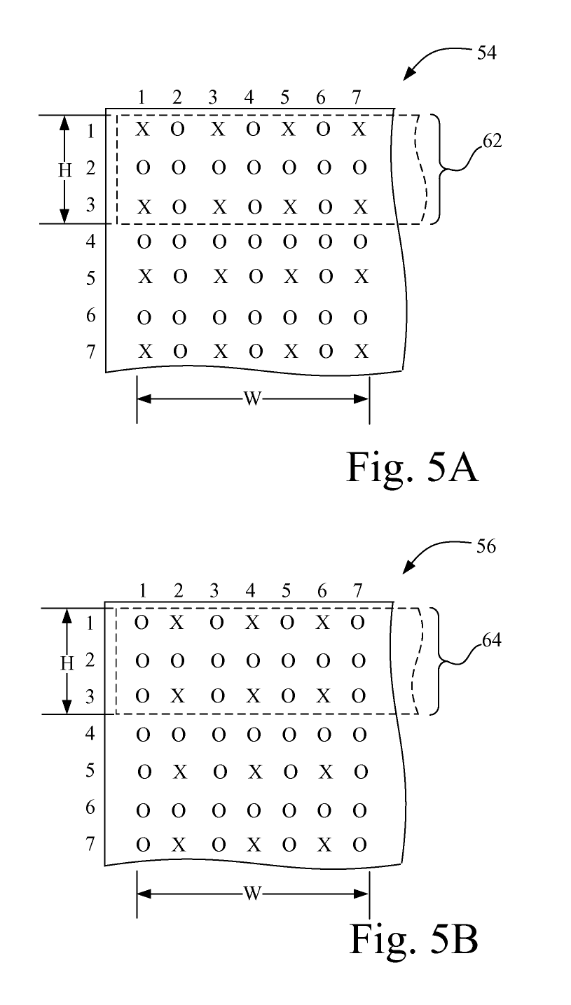

Referring now to FIG. 4, an exemplary high resolution image 52; steps S100-S116 are described herein with reference to high resolution image 52. The process of steps S100-S116 is described via an exemplary four pass printing mode, wherein four passes of ink jet printhead 36 are employed to deposit ink droplets at all pixel locations on the print grid. It will be appreciated by those skilled in the art that the principles set forth in the present description are applicable to multi-pass printing modes having more than four passes and having less than four passes, without departing from the scope of the present invention. For purposes of clarity, high resolution image 52 is only partially depicted, i.e., an upper left hand section. Each “X” on image 52 represents a pixel location where an ink droplet may be printed, depending upon the results of the halftoning process, wherein a print/no print decision is made for each pixel location.

The numerals 1-7 at the top of image 52 represent column numbers for pixel locations on the print grid, and the numerals 1-7 on the left side of image 52 represent row numbers for pixel locations on the print grid.

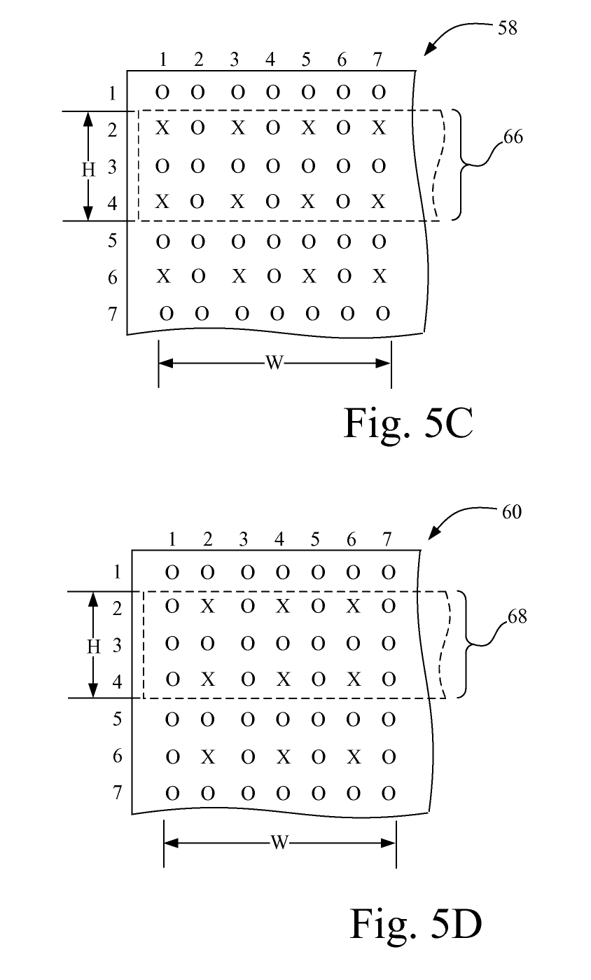

Referring now to FIGS. 5A-5D, at step S100, high resolution image 52 is subdivided into a plurality of low resolution sub-images. The number of low resolution sub-images of the present invention corresponds with the number of passes associated with the multi-pass print mode. Since the present example is described with respect to a four-pass print mode, there are four sub-images, which are depicted as low resolution sub-images 54, 56, 58 and 60.

In each of FIGS. 5A-5D, each “X” represents a pixel location where an ink droplet may be printed, depending upon the print/no print decision made during halftoning. Each “O” in each of FIGS. 5A-5D represents a pixel location that is not processed as part of the particular low-resolution sub-image, and hence, for the particular low-resolution sub-image, represents a pixel location where a print/no print decision is not made—these pixel locations are ignored for the particular low resolution sub-image, and addressed in other low resolution sub-images. Because high resolution image 52 has a higher vertical resolution than the vertical nozzle pitch of the printhead, there are rows of pixel positions in each low resolution sub-image for which there are no corresponding nozzles. These rows are represented by all “O's” in FIGS. 5A-5D, and are printed in subsequent passes, as part of other low resolution sub-images.

As with the depiction of image 52 in FIG. 4, the numerals 1-7 at the tops of low resolution sub-images 54, 56, 58 and 60 represent column numbers for pixel locations on the print grid, and the numerals 1-7 on the left sides of low resolution sub-images 54, 56, 58 and 60 represent row numbers for pixel locations on the print grid.

It will be apparent that the combining of low resolution sub-images 54, 56, 58 and 60 yields high resolution image 52. For example, by superimposing each of low resolution sub-images 54, 56, 58 and 60, each pixel location would have a corresponding print/no print decision, and hence may receive an ink droplet, depending, or course, on whether such an ink droplet is required by the image data. Sub-images 54, 56, 58 and 60 are defined as being “low resolution” because they are subdivisions of the original image that include less pixel locations for which dots may be printed than high resolution image 52, which are indicated by the “X” in the indicated rows and columns of the print grid. Thus, the low-resolution sub-images do not represent color planes, but rather, represent subsets of the entire image, without differentiating as to color. Accordingly, whether high resolution image 52 is a color image or a monochrome image, in accordance with the present invention it is divided into low resolution sub-images.

At step S102, each low resolution sub-image of the plurality of low resolution sub-images is subdivided into a plurality of low resolution swath portions. One such low resolution swath portion is depicted for each of low resolution sub-images 54, 56, 58 and 60, namely, low resolution swath portions 62, 64, 66 and 68, respectively. Each low resolution swath portion has a height H corresponding to the swath height of the printhead Although ink jet printhead 36 is depicted as having some number of nozzles greater than two in FIG. 2, for purposes of the present description of steps S100-S116, it will be assumed that ink jet printhead 36 is two nozzles high in the vertical direction. Each low resolution swath portion 62, 64, 66 and 68 extends in horizontal direction 40, and has a width W corresponding to the width of image 52, which is thus also indicated by “W” on FIG. 4. For example, if image 52 is five inches wide, each low resolution swath portion is five inches wide. Where the width of image 52 varies, e.g., for an image having side edges that are not vertical straight lines, the width of a low resolution swath portion at any given vertical location is the same as the width of the image at the same vertical location.

In practice, it will be understood that there may be no discrete subdivision of the entire original image, i.e., the entire high resolution image being subdivided into a plurality of sub-images at a particular discrete point in the processing and printing of the image. Rather, the subdivision may be made by selecting which pixel positions will be processed, which is based on the number of passes in the multi-pass mode. For example, in a four-pass printing mode, the odd pixel rows and odd pixel columns may be processed and printed in one pass, the odd pixel rows and even pixel columns may be then processed and printed in a next pass, the even pixel rows and odd pixel columns may be then processed and printed in a third pass, and the even pixel rows and even pixel columns may be then processed and printed in a fourth pass, after which the cycle is repeated until the entire image has been processed. The page 28 may be indexed between each pass, or may be indexed after completing each group of four passes. Thus, by selecting a four-pass printing mode, the pixel row and pixel column combinations that make up each low resolution sub-image are determined, and hence, the original image has thus been effectively subdivided into low resolution sub-images.

Similarly, it is not necessary that the subdivision of the low resolution sub-image into low resolution swath portions be performed at a particular discrete point in the processing of the image. For example, in practice, each raster line of a low resolution sub-image may be supplied as data that is input into the halftoning function of controller 18, and is repeatedly performed until a desired number of raster lines are processed, wherein the desired number of raster lines is what defines the swath height for the low resolution swath portion.

At step S104, an amount of memory 50 is allocated for buffer storage, the amount being only sufficient to store data corresponding to less than two of the low resolution swath portions. In the present embodiment, memory 50 is sized to store data pertaining to only a single low resolution swath portion.

At step S106, for the first/next low resolution swath portion of said plurality of low resolution swath portions is halftoned to generate a corresponding halftoned low resolution swath portion. Ultimately, each low resolution swath portion will have been processed when the image is completely printed. The halftoning of each low resolution swath portion of a particular low resolution sub-image is performed independently of the halftoning of low resolution swath portions of other low resolution sub-images. For example, the halftoning of low resolution swath portion 62 and other low resolution swath portions of low resolution sub-image 54 is performed independently of the halftoning of low resolution swath portions of other low resolution sub-images, such as low resolution swath portions 64, 66 and 68 of low resolution sub-images 56, 58 and 60, respectively. That is, the halftoning performed on a low resolution swath portion of any low resolution sub-image is not based on any halftoning performed on any low resolution swath portions of any other low resolution sub-images.

At step S108, the halftoned low resolution swath portion is stored into the allocated amount of memory 50, which in the present embodiment is the entire memory. In some embodiments, it is considered that each low resolution swath portion may be compressed prior to storing the halftoned low resolution swath portion, e.g., may be compressed as part of step S108, prior to storing the halftoned result, in which case the amount of memory for buffer storage is only sufficient for storing data corresponding to a single compressed low resolution swath portion, thereby allowing a further reduction in the size of buffer memory 50.

At step S110, the halftoned low resolution swath portion is formatted and then printed.

Steps S106, S108, S110 and S112 are performed sequentially for each low resolution swath portion. That is, steps S106, S108, S110 and S112 are performed until completion of a given low resolution swath portion prior to processing the next low resolution swath portion. Thus, any given halftoned low resolution swath portion is printed prior to halftoning the next low resolution swath portion and storing the next corresponding halftoned low resolution swath portion.

At step S112, the entire allocated memory amount is cleared, in preparation for halftoning the next low resolution swath portion.

In the present embodiment, the halftoning of each low resolution swath portion, the storing of the halftoned low resolution swath portion, and the printing of each halftoned low resolution swath portion are performed once for each low resolution sub-image prior to performing a next iteration of the halftoning, storing and printing of a low resolution swath portion for a same low resolution sub-image. That is, a second iteration of steps S106-S112 is not performed on any low resolution sub-image until a first iteration of steps S106-S112 has been performed for all of the low resolution sub-images.

Accordingly, at step S114, steps S106 to S112 are repeated for the next low resolution sub-image until each low resolution sub-image has been processed once, i.e., until one low resolution swath portion for each low resolution sub-image has been halftoned, stored and printed. In the present embodiment, page 28 is indexed after each printing operation, i.e., after each instance of step S110, although in other embodiments, it is alternatively contemplated that page 28 may not be indexed after each printing operation, but rather, for example, may be indexed only after completion of each instance of step S114, i.e., after one low resolution swath portion for each low resolution sub-image has been processed.

At step S116, Steps S106-S114 are repeated until high resolution image 52 has been completely printed, after which point memory 50 is de-allocated, which frees memory 50 for other purposes.

As would be appreciated by those skilled in the art, the present invention method of printing a high resolution image in a multi-pass print mode may reduce the required size of memory 50, which may reduce the cost of imaging apparatus 12.

While this invention has been described with respect to embodiments of the invention, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A method of printing a high resolution image with a printhead in a multi-pass printing mode, comprising:
subdividing said high resolution image into a plurality of low resolution sub-images;
subdividing each low resolution sub-image of said plurality of low resolution sub-images into a plurality of low resolution swath portions;
allocating an amount of a memory for buffer storage, said amount being only sufficient to store data corresponding to less than two of said low resolution swath portions; and
for each low resolution swath portion of said plurality of low resolution swath portions:
halftoning said each low resolution swath portion to generate a corresponding halftoned low resolution swath portion, said halftoning of said each low resolution swath portion of a particular low resolution sub-image being performed independently of halftoning said low resolution swath portions of other low resolution sub-images of said plurality of low resolution sub-images;
storing said halftoned low resolution swath portion into said amount of said memory; and
printing said halftoned low resolution swath portion.

2. The method of claim 1, wherein said halftoning said each low resolution swath portion, said storing said halftoned low resolution swath portion, and said printing said halftoned low resolution swath portion are performed once for said each low resolution sub-image of said plurality of low resolution sub-images prior to performing a next said halftoning said each low resolution swath portion, said storing said halftoned low resolution swath portion, and said printing said halftoned low resolution swath portion for a same said each low resolution sub-image of said plurality of low resolution sub-images.

3. The method of claim 1, wherein said halftoning said each low resolution swath portion, said storing said halftoned low resolution swath portion, and said printing said each low resolution swath portion are performed for said each low resolution swath portion sequentially.

4. The method of claim 1, wherein said each low resolution swath portion has a height corresponding to a swath height of said printhead.

5. The method of claim 1, wherein said printing said halftoned low resolution swath portion is performed prior to said halftoning a next low resolution swath portion and said storing a next corresponding halftoned low resolution swath portion.

6. The method of claim 1, wherein said image has an image width at a location of said each low resolution swath portion, and wherein said each low resolution swath portion has a width corresponding to said image width at said location.

7. The method of claim 1, wherein said memory is sized to store data pertaining to only a single low resolution swath portion of said plurality of low resolution swath portions.

8. The method of claim 1, wherein a number of low resolution sub-images forming said plurality of low resolution sub-images corresponds to the number of passes associated with said multi-pass printing mode.

9. The method of claim 1, further comprising clearing the entire said amount of said memory after said printing said halftoned low resolution swath portion and before halftoning a next low resolution swath portion of said plurality of low resolution swath portions.

10. The method of claim 1, further comprising compressing said each low resolution swath portion prior to said storing said halftoned low resolution swath portion, wherein said amount of a memory for buffer storage is only sufficient for storing data corresponding to a single compressed low resolution swath portion.

11. An imaging apparatus configured for printing a high resolution image in a multi-pass printing mode, comprising:
a printhead;
a print engine having a reciprocating printhead carrier configured to carry said printhead; and
at least one of a controller and an imaging driver; and
a memory,
wherein said at least one of said controller and said imaging driver are configured for executing program instructions for printing in a multi-pass printing mode by:
subdividing said high resolution image into a plurality of low resolution sub-images;
subdividing each low resolution sub-image of said plurality of low resolution sub-images into a plurality of low resolution swath portions;
allocating an amount of said memory for buffer storage, said amount being only sufficient to store data corresponding to less than two of said low resolution swath portions; and
for each low resolution swath portion of said plurality of low resolution swath portions:
halftoning said each low resolution swath portion to generate a corresponding halftoned low resolution swath portion, said halftoning of said each low resolution swath portion of a particular low resolution sub-image being performed independently of halftoning said low resolution swath portions of other low resolution sub-images of said plurality of low resolution sub-images;
storing said halftoned low resolution swath portion into said amount of said memory; and
printing said halftoned low resolution swath portion.

12. The imaging apparatus of claim 11, wherein said halftoning said each low resolution swath portion, said storing said halftoned low resolution swath portion, and said printing said halftoned low resolution swath portion are performed once for said each low resolution sub-image of said plurality of low resolution sub-images prior to performing a next said halftoning said each low resolution swath portion, said storing said halftoned low resolution swath portion, and said printing said halftoned low resolution swath portion for a same low resolution sub-image of said plurality of low resolution sub-images.

13. The imaging apparatus of claim 11, wherein said halftoning said each low resolution swath portion, said storing said halftoned low resolution swath portion, and said printing said each low resolution swath portion are performed for said each low resolution swath portion sequentially.

14. The imaging apparatus of claim 11, wherein said each low resolution swath portion has a height corresponding to a swath height of said printhead.

15. The imaging apparatus of claim 11, wherein said printing said halftoned low resolution swath portion is performed prior to said halftoning a next low resolution swath portion and said storing a next corresponding halftoned low resolution swath portion.

16. The imaging apparatus of claim 11, wherein said image has an image width at a location of said each low resolution swath portion, and wherein said each low resolution swath portion has a width corresponding to said image width at said location.

17. The imaging apparatus of claim 11, wherein said memory is sized to store data pertaining to only a single low resolution swath portion of said plurality of low resolution swath portions.

18. The imaging apparatus of claim 11, wherein a number of low resolution sub-images forming said plurality of low resolution sub-images corresponds to the number of passes associated with said multi-pass printing mode.

19. The imaging apparatus of claim 11, further comprising clearing the entire said amount of said memory after said printing said halftoned low resolution swath portion and before halftoning a next low resolution swath portion of said plurality of low resolution swath portions.

20. The imaging apparatus of claim 11, further comprising compressing said each low resolution swath portion prior to said storing said halftoned low resolution swath portion, wherein said amount of a memory for buffer storage is only sufficient for storing data corresponding to a single compressed low resolution swath portion.
